(19) United States
(12) Patent Application Publication
(10) Pub. No.: US 2025/0300553 A1
(43) Pub. Date: Sep. 25, 2025

(54) AUXILIARY POWER SUPPLY CIRCUIT AND POWER SUPPLY DEVICE

(71) Applicant: SHARP KABUSHIKI KAISHA, Osaka (JP)

(72) Inventor: TAKESHI SHIOMI, Osaka (JP)

(21) Appl. No.: 19/050,453

(22) Filed: Feb. 11, 2025

(30) Foreign Application Priority Data
Mar. 25, 2024 (JP) 2024-047400

(51) Int. Cl. H02M 3/155; H02M 1/00; H02M 1/36; H02M 1/44

(52) U.S. Cl. CPC H02M 3/155; H02M 1/0095; H02M 1/36; H02M 1/44

(57) ABSTRACT

An auxiliary power supply circuit connected to a switching circuit in which a high-withstand-voltage transistor and a low-withstand-voltage transistor are connected in series includes a rectification element and an auxiliary power supply capacitor. A connection node between the high-withstand-voltage transistor and the low-withstand-voltage transistor is connected to an anode of the rectification element. A cathode of the rectification element is connected to a positive electrode of the auxiliary power supply capacitor. A negative electrode of the auxiliary power supply capacitor is connected to a reference terminal of the low-withstand-voltage transistor.

### CROSS-REFERENCE TO RELATED APPLICATION

The present application claims priority from Japanese Application JP2024-047400, filed on Mar. 25, 2024, the content of which is hereby incorporated by reference into this application.

### BACKGROUND

### 1. Field

The following disclosure relates to an auxiliary power supply circuit and a power supply device.

### 2. Description of the Related Art

Japanese Unexamined Patent Application Publication No. 2016-220468 is disclosed as an example of the configuration of an auxiliary power supply circuit.

### SUMMARY

However, even if such an auxiliary power supply circuit is used, there is still room for improvement.

The Specification discloses an auxiliary power supply circuit and a power supply device that can effectively use the power of a switching circuit.

To solve the above problem, an auxiliary power supply circuit according to one aspect of the present disclosure is connected to a switching circuit.

The switching circuit includes a high-withstand-voltage transistor and a low-withstand-voltage transistor connected in series. The high-withstand-voltage transistor is disposed on a high-voltage side. The low-withstand-voltage transistor is disposed on a low-voltage side.

The auxiliary power supply circuit includes a rectification element, and an auxiliary power supply capacitor.

A connection node between the high-withstand-voltage transistor and the low-withstand-voltage transistor is connected to an anode of the rectification element.

A cathode of the rectification element is connected to a positive electrode of the auxiliary power supply capacitor.

A negative electrode of the auxiliary power supply capacitor is connected to a reference terminal of the low-withstand-voltage transistor.

A voltage at the connection node generated when the switching circuit operates is supplied to the auxiliary power supply capacitor.

To solve the above problem, a power supply device according to one aspect of the present disclosure includes the auxiliary power supply circuit.

The present disclosure enables effective use of the power of the switching circuit.

### BRIEF DESCRIPTION OF THE DRAWINGS

FIG. 1 is a diagram illustrating an auxiliary power supply circuit according to an embodiment of the present disclosure;

FIG. 2 is a diagram illustrating the operation of the auxiliary power supply circuit according to an embodiment of the present disclosure;

FIG. 3 is a diagram illustrating a startup circuit that can be used in the auxiliary power supply circuit according to an embodiment of the present disclosure; and

FIG. 4 is a diagram illustrating a power supply device including the auxiliary power supply circuit according to the embodiment of the present disclosure.

### DETAILED DESCRIPTION OF THE DISCLOSURE

### First Embodiment

In the Specification, a rectification element RCT1 will be also simply referred to as RCT1 as an example of the description of a sign in the drawings.

The following lists abbreviations that are used: MOS stands for a metal-oxide-semiconductor field-effect transistor; SJMOS stands for a super-junction metal-oxide-semiconductor field-effect transistor; IGBT stands for an insulated-gate bipolar transistor; JFET stands for a junction field effect transistor; HEMT stands for a high electron mobility transistor; LDO stands for a low dropout linear regulator; and IC stands for an integrated circuit of semiconductor.

A transistor is defined as follows. A transistor includes a control terminal, a reference terminal, and a high-voltage terminal. The transistor can be turned on by voltage application to the control terminal with respect to the reference terminal. Turning on the transistor allows current to flow from the high-voltage terminal through the reference terminal, or from the reference terminal through the high-voltage terminal. When the transistor is off, the high-voltage terminal receives voltage with respect to the reference terminal, so that current conduction can be limited.

Transistors include, but not limited to, a MOS, an SJMOS, an IGBT, a GaN-HEMT, and a SiC-JFET having these definitions.

This embodiment describes an example where an auxiliary power supply circuit is replaced with a gate-drive power supply circuit, where an auxiliary power supply capacitor is replaced with a gate drive capacitor, and where a Zener diode for an auxiliary power supply capacitor is replaced with a Zener diode for a gate drive capacitor.

The auxiliary power supply circuit according to this embodiment is available for various power supply applications, such as a power supply circuit for a control circuit, and a power supply circuit for controlling a mechanical relay, other than a gate-drive power supply circuit.

### (Overview of Gate-Drive Power Supply Circuit)

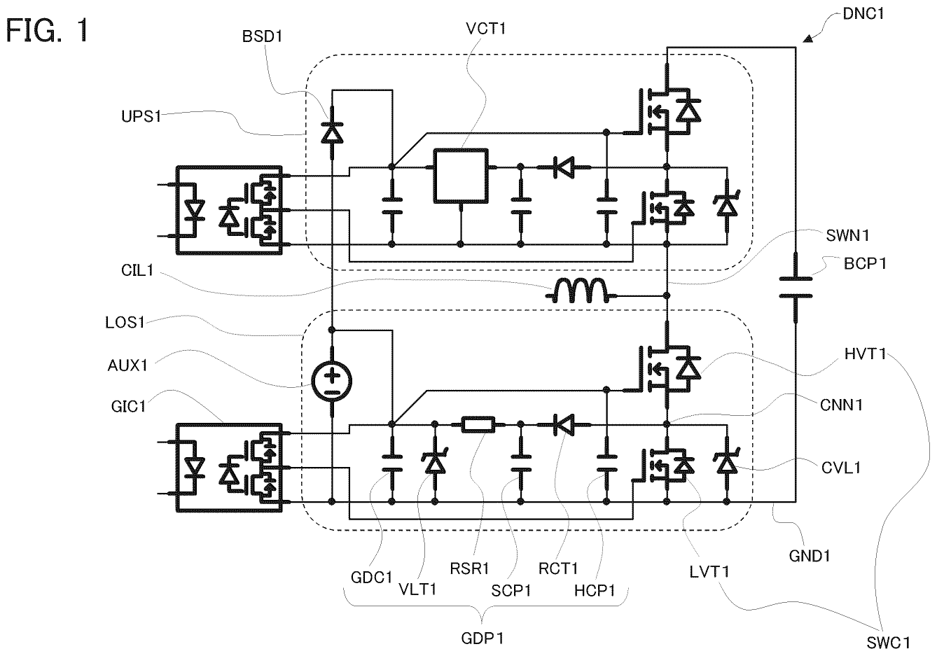

A gate-drive power supply circuit GDP1 in the present disclosure will be described with reference to FIG. 1.

Typical gate-drive power supply circuits face a power consumption problem in typical auxiliary power supplies, which are supply sources. The gate-drive power supply circuit GDP1 in the present disclosure is configured to receive power from a switching circuit SWC1 to effectively use the power, thereby enabling power savings in typical auxiliary power supplies.

### (Main Constituents of Gate-Drive Power Supply Circuit)

FIG. 1 shows a lower arm LOS1 including SWC1 and GDP1, and an upper arm UPS1 having the same functions. GDP1 will be described by mainly using LOS1.

GDP1 is connected to SWC1.

SWC1 includes a high-withstand-voltage transistor HVT1 and a low-withstand-voltage transistor LVT1 in series, in which a reference terminal of HVT1 and a high-voltage terminal of LVT1 are connected together. HVT1 is disposed on the high-voltage side of a bus capacitor BCP1, which constitutes circuit voltage, and LVT1 is disposed on the low-voltage side of BCP1. The ON and OFF periods of SWC1 coincide with ON and OFF periods shared by HVT1 and LVT1.

GDP1 includes a rectification element RCT1 and a gate drive capacitor GDC1. A connection node CNN1 between HVT1 and LVT1 is connected to an anode of RCT1, and a cathode of RCT1 is connected to a positive electrode of GDC1. A negative electrode of GDC1 is connected to a reference terminal of LVT1 and a reference node GND1, which is a negative electrode of BCP1.

By the use of the foregoing GDC1's main constituents, a voltage of CNN1 generated when SWC1 is turned off brings RCT1 into electrical continuity, thus charging GDC1. At CNN1 reduced from charged GDC1 by the SWC1's turn-on, RCT1 interrupts electrical current continuity. SWC1's repeated ON-OFF switching operations supply direct-current voltage and power to GDC1.

SWC1 is switched between ON and OFF by a gate drive IC (GIC1) driving a gate of LVT1 by the use of the GDC1's power.

### (Definition of Upper-Limit Voltage of Gate Drive Capacitor GDC1)

A voltage of GDC1 generated from CNN1, which, unlike a typical auxiliary power supply, has no voltage guarantee, may possibly become an overvoltage. To avoid such an overvoltage, a cathode of a Zener diode VLT1 for a gate drive capacitor is connected to the GDC1's positive electrode, and an anode of the same is connected to the GDC1's negative electrode. An upper-limit voltage of GDC1 is defined by a Zener voltage of VLT1, so that an overvoltage surpassing the upper limit can be avoided.

A Zener diode CVL1 can be also connected in parallel with LVT1 for the purpose of noise reduction and other purposes, as well as improvement in the voltage controllability of GDC1.

### (Avoiding Surge Current of Gate Drive Capacitor GDC1 Using Resistor)

CNN1's voltage change resulting from the SWC1's switching is steep, thus generating a surge current. The surge current, which propagates to GDC1, becomes noise and may possibly destabilize the operation of GIC1, which is connected to GDC1.

To reduce the GDC1's noise, a smoothing capacitor SCP1 and an inrush-current limiting resistor RSR1 can be added.

SCP1 is added in such a manner that its positive electrode is connected to the RCT1's cathode, and that its negative electrode is connected to the LVT1's reference terminal. RSR1 is interposed on a connection path between the RCT1's cathode and the GDC1's positive electrode.

The addition of SCP1 and RSR1 diverts the surge current generated in CNN1, to SCP1 and feeds it back to the LVT1's reference terminal. In addition, surge current propagation to GDC1 is limited by RSR1, so that GDC1 can operate stably.

### (Preventing Surge Current of Gate Drive Capacitor GDC1 Using LDO)

To reduce GDC1's further noise, RSR1 can be replaced with VCT1, which is an LDO. An LDO can keep an output voltage constant and can thus also eliminate the need for connecting VLT1.

UPS1 is a circuit with RSR1 of LOS1 being replaced with VCT1, and with VLT1 being omitted. The elements of UPS1, which includes the same elements as those of LOS1, are not denoted by signs.

VCT1 has an input terminal connected to the cathode of the rectification element, an output terminal connected to the positive electrode of the gate drive capacitor, and a reference terminal connected to the reference terminal of the low-withstand-voltage transistor.

VCT1 can further prevent surge current propagation to GDC1.

### (Connecting Auxiliary Power Supply AUX1 to Gate Drive Capacitor GFC1)

GDP1 cannot supply direct-current voltage and power to GDC1 while SWC1 is not performing switching operations. Accordingly, power supply from a general auxiliary power supply AUX1 to GDC1 can ensure power while SWC1 is not performing the switching operations.

AUX1 is additionally connected to GDC1 in such a manner that a positive electrode of AUX1 is connected to the GDC1's positive electrode, and that a negative electrode of AUX1 is connected to the GDC1's negative electrode.

Ideally, the power of AUX1 is used only when the switching is started, and thereafter, power received by GDP1 from SWC1 is used effectively.

To enable this ideal usage, an output voltage of AUX1 is preferably lower than a voltage of GDC1 supplied from GDP1. This is because GDC1 is charged with a higher power supply voltage, and the charged power is used in GIC1.

A typical auxiliary power supply can be used as AUX1; a possible example is a power supply for a flyback circuit.

### (Voltage Supply to Gate Drive Capacitor for High-Withstand-Voltage Transistor)

When HVT1 is an SJMOS, a SiC-MOS, or other kinds of transistor, voltage application to its control terminal is needed in some cases. In such cases, a gate drive capacitor HCP1 for a high-withstand-voltage transistor is used. HCP1 is disposed in such a manner that its positive electrode is connected to the HVT1's control terminal, and that its negative electrode is connected to the LVT1's reference terminal. Furthermore, the GDC1's positive electrode and the HCP1's positive electrode are connected together, thereby enabling voltage supply from GDC1 to HCP1.

### (Circuit for Evaluating Gate-Drive Power Supply Circuit GDP1)

The operation of GDP1 is checked using a down converter circuit DNC1 shown in FIG. 1.

DNC1 includes LOS1 with GND1 as a reference node, and UPS1 with a switch node SWN1 as a reference node. SWN1 includes a coil CIL1, and a low-voltage load (not shown) beyond the coil CIL1. UPS1 includes a bootstrap diode BSD1 instead of AUX1 included in LOS1. Each of HVT1 and LVT1 includes a parasitic diode having a cathode connected to the corresponding high-voltage terminal.

The gate drive IC controls the switching between UPS1 and LOS1, thereby generating a 200-volt voltage of the low-voltage load, from a 400-volt voltage of BCP1. DNC1 has a carrier frequency of 100 KHz.

AUX1 stands at 15 V, VLT1 has a Zener voltage of 17 V, and CVL1 has a Zener voltage of 30 V. GDC1, SCP1, and HCP1 have an electrostatic capacitance of 0.1 μF. RSR1 has a resistance of 100Ω. LVT1 is an N-channel MOS with a 30-volt withstanding voltage, and HVT1 is an N-channel SJMOS with a 600-volt withstanding voltage. Setting the withstand voltage of LVT1 at one tenth or less of the withstand voltage of HVT1 can lower the voltage of CNN1, thereby enabling GDC1 to be charged efficiently.

### (Evaluation on Operation of Gate-Drive Power Supply Circuit GDP1)

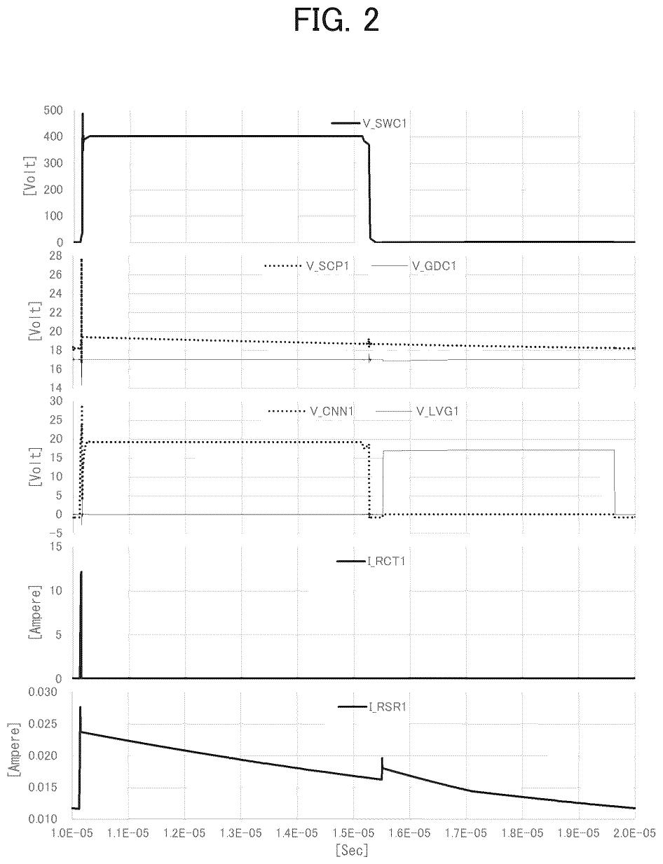

FIG. 2 shows five graphs of the operation waveforms of respective components related to GDP1. The horizontal axes of the five graphs are common and indicate time, and there are two kinds of vertical axes of the same: one is voltage (Volt), and the other is current (Ampere). V_SWC1 is the voltage of SWC1 and is also the voltage of SWN1 with respect to GND1. V_LVG1 is the gate-source voltage of LVT1. Other than the foregoing, a symbol prepended with the uppercase V denotes the voltage of a sign of the symbol's latter half, and a symbol prepended with the uppercase I denotes the current of a sign of the symbol's latter half. For instance, V_SCP1 denotes the voltage of SCP1, and I_RCT1 denotes the current of RCT1.

At around 1.02E-5 Sec, SWC1 is turned off, thus raising the voltage V_SWC1, and at the same time, raising the voltage V_CNN1 to 19 V. The rise of V_CNN1 causes SCP1 to be charged with 12 A of I_RCT1 via RCT1. On the other hand, I_RSR1 for charging GDC1 is limited to 0.027 A, thus enabling noise prevention. Furthermore, the graph reveals that V_SCP1, although involving a 1.5-volt voltage rise, can prevent noise because V_GDC1 fluctuates only a little. These noise reductions are attributed to SCP1 and RSR1. The graph also reveals that VLT1 functions so as not to surpass 17 V, which is an upper-limit gate-drive voltage, except noise in measurement. SCP1 having high voltage continues charging GDC1 with I_RSR1.

At around 1.53E-5 Sec, SWC1 is turned on by a flywheel current. To turn on LVT1 as a synchronous rectifier, GIC1 sets V_LVG1 at 17 V by using GDC1. The consumption of V_GDC1 is compensated by I_RSR1 deriving from V_SCP1. This GDC's voltage recovery through compensation can be confirmed at 1.58E-5 Sec. UPS1 can also operate in a manner similar to LOS1.

### Second Embodiment

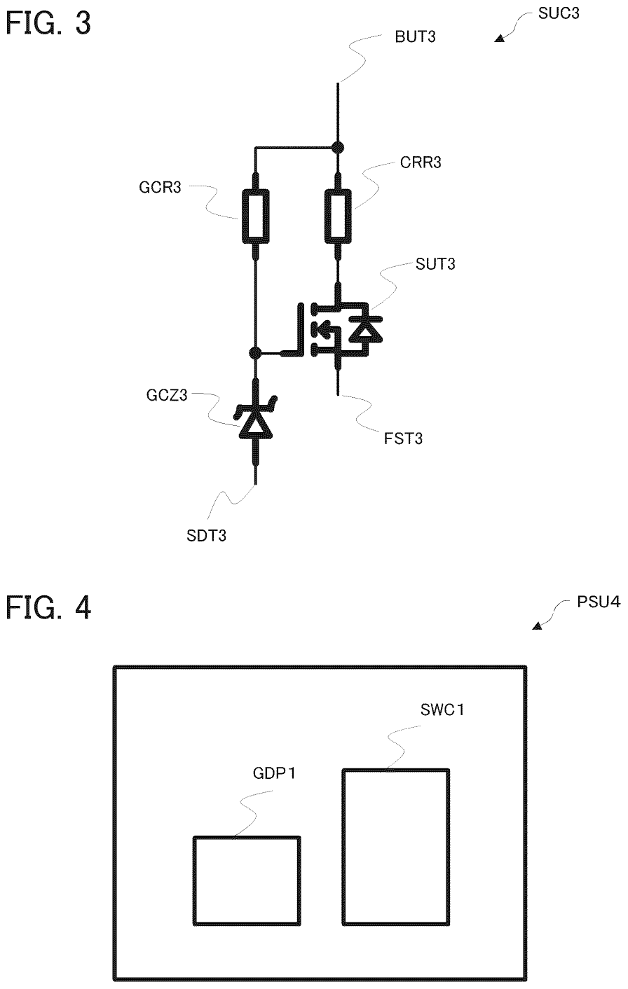

An example where AUX1 used before SWC1 starts up is replaced with a startup circuit SUC3 will be described with reference to FIG. 3.

SUC3 includes a startup transistor SUT3, a current limiting resistor CRR3, a gate controlling resistor GCR3, and a gate controlling Zener diode GCZ3. A terminal FST3 is connected to the GDC1's positive electrode, and a terminal SDT3 is connected to the GDC1's negative electrode. A terminal BUT3 is connected to a BUS-Line capable of power supply. Here, BUT3 is connected to a positive electrode of BCP1. This configuration can ensure power before the startup.

### Third Embodiment

A power supply device PSU4 shown in FIG. 4 includes GDP1 connected to SWC1. PSU4 can reduce consumed power by the use of GDP1.

It should be noted that the foregoing numeral values are merely illustrative. Possible techniques for adjusting the circuit operation include, but not limited to, interposing a resistor on a wiring line, and adding a capacitor between two wiring lines to increase electrostatic capacitance.

### ADDITIONAL NOTE

While there have been described what are at present considered to be certain embodiments of the disclosure, it will be understood that various modifications may be made thereto, and it is intended that the appended claim cover all such modifications as fall within the true spirit and scope of the disclosure.

What is claimed is:

1. An auxiliary power supply circuit connected to a switching circuit,
the switching circuit including a high-withstand-voltage transistor and a low-withstand-voltage transistor connected in series, the high-withstand-voltage transistor being disposed on a high-voltage side, the low-withstand-voltage transistor being disposed on a low-voltage side,
the auxiliary power supply circuit comprising a rectification element, and an auxiliary power supply capacitor,
wherein a connection node between the high-withstand-voltage transistor and the low-withstand-voltage transistor is connected to an anode of the rectification element,
a cathode of the rectification element is connected to a positive electrode of the auxiliary power supply capacitor,
a negative electrode of the auxiliary power supply capacitor is connected to a reference terminal of the low-withstand-voltage transistor, and
a voltage at the connection node generated when the switching circuit operates is supplied to the auxiliary power supply capacitor.

2. The auxiliary power supply circuit according to claim 1, further comprising an auxiliary-power-supply-capacitor Zener diode,
wherein the auxiliary-power-supply-capacitor Zener diode has
a cathode connected to the positive electrode of the auxiliary power supply capacitor, and
an anode connected to the negative electrode of the auxiliary power supply capacitor.

3. The auxiliary power supply circuit according to claim 1, further comprising a smoothing capacitor, and an inrush-current limiting resistor,
wherein the smoothing capacitor has
a positive electrode connected to the cathode of the rectification element, and
a negative electrode connected to the reference terminal of the low-withstand-voltage transistor, and
wherein the inrush-current limiting resistor is interposed on a connection path between the cathode of the rectification element and the positive electrode of the auxiliary power supply capacitor.

4. The auxiliary power supply circuit according to claim 1, further comprising a smoothing capacitor, and an LDO,
wherein the smoothing capacitor has
a positive electrode connected to the cathode of the rectification element, and
a negative electrode connected to the reference terminal of the low-withstand-voltage transistor,
wherein the LDO is interposed on a connection path between the cathode of the rectification element and the positive electrode of the auxiliary power supply capacitor, and
wherein the LDO has
an input terminal connected to the anode of the rectification element,
an output terminal connected to the positive electrode of the auxiliary power supply capacitor, and
a reference terminal connected to the reference terminal of the low-withstand-voltage transistor.

5. The auxiliary power supply circuit according to claim 1, further comprising a general auxiliary power supply,
wherein the general auxiliary power supply has
a positive electrode connected to the positive electrode of the auxiliary power supply capacitor, and
a negative electrode connected to the negative electrode of the auxiliary power supply capacitor.

6. The auxiliary power supply circuit according to claim 5, wherein an output voltage of the general auxiliary power supply is lower than a voltage of the auxiliary power supply capacitor.

7. The auxiliary power supply circuit according to claim 1, further comprising a startup circuit,
wherein the startup circuit charges the auxiliary power supply capacitor before the switching circuit operates.

8. The auxiliary power supply circuit according to claim 1, wherein
the auxiliary power supply circuit is a gate-drive power supply circuit,
the auxiliary power supply capacitor is a gate drive capacitor,
the gate-drive power supply circuit further comprises a high-withstand-voltage-transistor gate drive capacitor, and
a voltage is supplied from the gate drive capacitor to the high-withstand-voltage-transistor gate drive capacitor.

9. A power supply device comprising the auxiliary power supply circuit according to claim 1.
